(19) United States
(12) Patent Application Publication
(10) Pub. No.: US 2026/0084929 A1
(43) Pub. Date: Mar. 26, 2026

(54) SAFETY METHOD AND AN ELEVATOR DRIVE SYSTEM FOR AN ELEVATOR SYSTEM COMPRISING REDUCED BUFFERS

(71) Applicant: KONE Corporation, Helsinki (FI)

(72) Inventors: Ari KATTAINEN, HELSINKI (FI); Juha-Matti AITAMURTO, HELSINKI (FI)

(73) Assignee: KONE Corporation, Helsinki (FI)

(21) Appl. No.: 19/404,373

(22) Filed: Dec. 1, 2025

Related U.S. Application Data
(63) Continuation of application No. PCT/EP2023/067999, filed on Jun. 30, 2023.

(51) Int. Cl. B66B 5/02; B66B 5/00

(52) U.S. Cl. CPC B66B 5/02; B66B 5/0025; B66B 5/0031; B66B 5/0093

(57) ABSTRACT

A safety method is performed for an elevator system including reduced buffers. The method includes: detecting a reduced braking force of a hoisting machinery brake arrangement, and adjusting at least one limiting parameter limiting an elevator motion in response to detecting the reduced braking force, the elevator motion representing a motion of an elevator car of elevator system. An elevator drive system and an elevator system are also provided.

### TECHNICAL FIELD

The invention concerns in general the technical field of elevator systems. Especially the invention concerns safety of elevator systems.

### BACKGROUND

An elevator system comprises an elevator car configured to travel along an elevator shaft between floors, an elevator control system, and hoisting machinery system. The elevator car is driven with the hoisting machinery system by means of hoisting ropes, which run via a traction sheave of the hoisting machinery system. The elevator control system comprises a drive system for controlling an electric motor of the hoisting machinery system (e.g. power feed to the electric motor, speed of the electric motor, and torque of the electric motor) in order to move the elevator car along the elevator shaft. The drive system generates for example at least one drive profile, e.g. a speed profile and/or a torque profile, and drives the elevator car in accordance with the generated at least one drive profile.

The elevator system comprises further a safety equipment, such as a buffer, arranged in a pit of the elevator shaft to soften stopping of a motion the elevator car, if the elevator car attempts to run over a bottom floor towards the pit, by absorbing kinetic energy of the elevator car. Further, a separate buffer may be provided in the pit to soften stopping of a motion of a counterweight, if the elevator car attempts to run over a top floor towards a top of the elevator shaft, by absorbing kinetic energy of the counterweight. Typically, the buffers are dimensioned according to a nominal speed of the elevator car. In other words, typically a rated striking speed of the buffers corresponds to the nominal speed of the elevator car. In some cases, instead of the typical buffers, the elevator system may comprise reduced buffers, wherein the height of the buffers is reduced. The reduced buffers may be dimensioned so that the rated striking speed of the buffers is lower than the nominal speed of the elevator car.

The elevator system comprises further hoisting machinery brakes, which may be applied to stop unintended motion of the motion of the elevator car. Further, the elevator system may comprise an overspeed governor, which actuates electrically the hoisting machinery brakes to stop the motion of the elevator car if the speed of the elevator car exceeds an overspeed limit.

Different safety functions of the elevator system may require different braking forces of the hoisting machinery brakes to stop the motion of the elevator car. For example, in response to detecting that the speed of the elevator car exceeds the overspeed limit, in case of the conventional buffers, i.e. not reduced buffers, a braking force, which enables that the motion of the elevator car can be slowed down, is sufficient, because it does not matter, if the elevator car runs into, i.e. collides, to the buffers, because the rated striking speed of the buffers corresponds to the nominal speed of the elevator car. However, in case of the reduced buffers a higher braking force is required, because the rated striking speed of the buffers is lower than the nominal speed of the elevator car.

Typically, the drive system of the elevator system may be used for monitoring the braking force of the hoisting machinery brakes. Conventionally, in response to detecting by the drive system that the braking force of the hoisting machinery brakes is reduced, the elevator system needs to be taken out of service.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, and an elevator drive system for an elevator system comprising reduced buffers and an elevator system. Another objective of the invention is that the method and the elevator drive system for an elevator system comprising reduced buffers and the elevator system enables that the operation of the elevator system may be continued when a reduced braking force of a hoisting machinery brake arrangement is detected.

The objectives of the invention are reached by a method, an elevator drive system and an elevator system as defined by the respective independent claims.

According to a first aspect, a safety method for an elevator system comprising reduced buffers is provided, wherein the method comprises: detecting a reduced braking force of a hoisting machinery brake arrangement, and adjusting at least one limiting parameter limiting an elevator motion in response to detecting the reduced braking force, wherein the elevator motion represents a motion of an elevator car of elevator system.

The reduced braking force may be detected during a condition monitoring test of the hoisting machinery brake arrangement.

Alternatively or in addition, the detecting the reduced braking force may comprise detecting that a braking force of at least one hoisting machinery brake of the hoisting machinery brake arrangement decreases below a predefined braking force limit.

The adjusting of the at least one limiting parameter may comprise reducing an overspeed limit of the elevator car.

The overspeed limit of the elevator car may be reduced to a rated striking speed of the buffers or to a speed value corresponding to the reduced braking force.

Alternatively or in addition, the adjusting of the at least one limiting parameter may comprise reducing limit values of Emergency Terminal Speed Limiting (ETSL) devices of the elevator system.

The limit values of the ETSL devices may be reduced to a rated striking speed of the buffers or to limit values corresponding to the reduced braking force.

Alternatively or in addition, the adjusting of the at least one limiting parameter may comprise reducing a maximum speed of an elevator speed profile.

The maximum speed of the elevator speed profile may be reduced to a rated striking speed of the buffers or to a maximum speed value corresponding to the reduced braking force.

According to a second aspect, an elevator drive system of an elevator system comprising reduced buffers is provided, wherein the elevator drive system comprises: at least one processor; and at least one memory including computer program code; wherein the at least one memory and the computer program code are configured to, with the at least one processor, cause the elevator drive system to perform: detect a reduced braking force of a hoisting machinery brake arrangement, and adjust at least one limiting parameter limiting an elevator motion in response to detecting the reduced braking force, wherein the elevator motion represents a motion of an elevator car of elevator system.

The reduced braking force may be detected during a condition monitoring test of the hoisting machinery brake arrangement.

Alternatively or in addition, the detection of the reduced braking force may comprise that the elevator drive system is configured to detect that a braking force of at least one hoisting machinery brake of the hoisting machinery brake arrangement decreases below a predefined braking force limit.

The adjusting of the at least one limiting parameter may comprise that the elevator drive system is configured to reduce an overspeed limit of the elevator car.

The overspeed limit of the elevator car may be reduced to a rated striking speed of the buffers or to a speed value corresponding to the reduced braking force.

Alternatively or in addition, the adjusting of the at least one limiting parameter may comprise that the elevator drive system is configured to reduce limit values of Emergency Terminal Speed Limiting (ETSL) devices of the elevator system.

The limit values of the ETSL devices may be reduced to a rated striking speed of the buffers or to limit values corresponding to the reduced braking force.

Alternatively or in addition, the adjusting of the at least one limiting parameter may comprise that the elevator drive system is configured to reduce a maximum speed of an elevator speed profile.

The maximum speed of the elevator speed profile may be reduced to a rated striking speed of the buffers or to a maximum speed value corresponding to the reduced braking force.

According to a third aspect, an elevator system is provided, wherein the elevator system comprises: an elevator car arranged to travel along an elevator shaft; a reduced buffer arrangement comprising reduced buffers; a hoisting machinery brake arrangement comprising at least two hoisting machinery brakes; and an elevator drive system as described above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator system.

FIG. 2 illustrates schematically an example of a safety method for the elevator system.

FIG. 3 illustrates schematically another example of the method.

FIG. 4 illustrates schematically an example of components of an elevator drive system.

### DESCRIPTION OF THE EXEMPLIFYING EMBODIMENTS

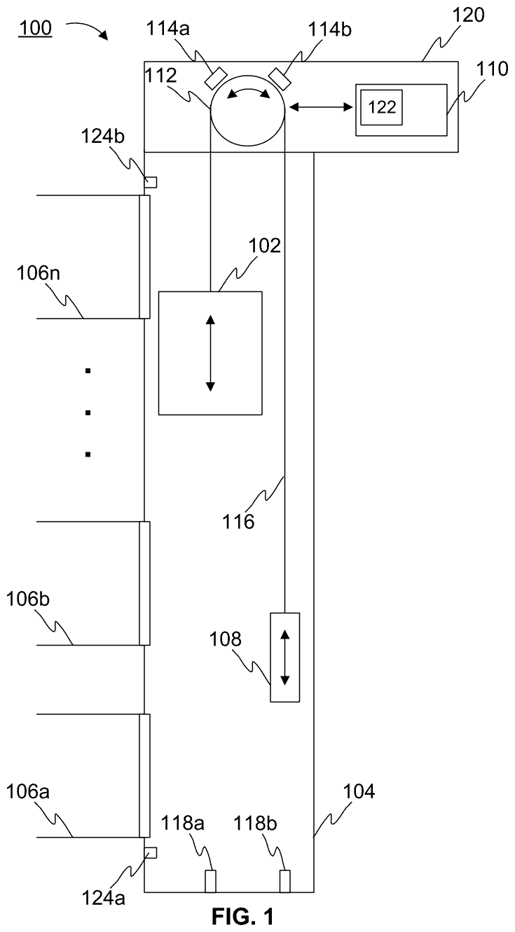

FIG. 1 illustrates schematically an example of an elevator system 100. The elevator system 100 comprises an elevator car 102 configured to travel along a respective elevator shaft 104 between a plurality of floors (i.e. landings) 106a-106n, a counterweight 108, an elevator hoisting machinery system, a reduced buffer arrangement, and an elevator control system 110. The elevator system 100 may also form an elevator group, i.e. group of two or more elevator cars 102 each travelling along a separate elevator shaft 104 configured to operate as a unit serving the same landings 106a-106n. The elevator hoisting machinery system is configured to drive the elevator car 102 along the elevator shaft 104 between the floors 106a-106n. The elevator hoisting machinery system comprises an electric motor and a traction sheave 112 for lifting the elevator car 102. The elevator hoisting machinery system further comprises a hoisting machinery brake arrangement comprising at least two hoisting machinery brakes 114a, 114b directly effecting to the traction sheave 112 to stop unintended motion of the elevator car 102. In the example of FIG. 1, the elevator hoisting machinery brake arrangement comprises two hoisting machinery brakes 114a, 114b. However, the hoisting machinery brake arrangement may also comprise more than two hoisting machinery brakes. Further, the elevator system 100 may comprise an overspeed governor for supervising speed of the elevator car 102. For sake of clarity the overspeed governor is not shown in FIG. 1. The overspeed governor may actuate electrically the hoisting machinery brakes 114a, 114b to stop the motion of the elevator car 102, if the speed of the elevator car 102 exceeds an overspeed limit. For illustrative purposes, only the traction sheave 112 and the hoisting machinery brakes 114a, 114b of the elevator hoisting machinery system are shown in FIG. 1. The elevator car 102, the elevator hoisting machinery system, and the counterweight 108 are interconnected via hoisting roping arrangement 116 routed via the traction sheave 112 and a plurality of pulleys, which are not shown in FIG. 1 for sake of clarity. When the traction sheave 112 rotates, the elevator car 102 and the counterweight 108 are moving. The hoisting roping arrangement 116 comprises at least one hoisting rope or belt. The reduced buffer arrangement comprises a reduced car buffer 118a and a reduced counterweight buffer 118b. The reduced car buffer 118a is arranged in the pit of the elevator shaft 104 to soften stopping of the motion the elevator car 102, if the elevator car 102 attempts to run over a bottom floor 106a towards the pit, by absorbing kinetic energy of the elevator car 102. The reduced counterweight buffer 118b is arranged in the pit of the elevator shaft 104 to soften stopping of a motion of the counterweight 108, if the elevator car 102 attempts to run over a top floor 106n towards a top of the elevator shaft 104, by absorbing kinetic energy of the counterweight 108. The height of the reduced buffers 118a, 118b is reduced in comparison to the height of conventional buffers, which are dimensioned according to a nominal speed of the elevator car 102. The reduced buffers 118a, 118b may be for example be dimensioned so that a rated striking speed of the buffers 118a, 118b is lower than the nominal speed of the elevator car 102. The rated striking speed of the buffers 118a, 118b represents the maximum permitted speed of the respective elevator entity (the elevator car 102 or the counterweight 108 depending on the buffer 118a, 118b) at which said elevator entity is allowed to run into the buffer 118a, 118b so that the buffer 118a, 118b is still capable to soften the stopping of the respective elevator entity 102, 108.

The elevator control system 110 is configured to at least control the operations of the elevator system 100. The elevator control system 110 may locate inside a machine room 120 (as illustrated in the example of FIG. 1) or at one of the floors 106a-106n, e.g. in a machine roomless elevator system. The elevator control system 110 is communicatively coupled to the other entities of the elevator system 100. The communication between the elevator control system 110 and the other entities of the elevator system 100 may be based on one or more known communication technologies, either wired or wireless. The implementation of the elevator control system 110 may be done as a stand-alone control entity or as a distributed control environment between a plurality of stand-alone control entities, such as a plurality of servers, providing distributed control resource. The elevator control system 110 comprises an elevator drive system 122 for controlling the electric motor of the elevator hoisting machinery (e.g. power feed to the electric motor, speed of the electric motor, and torque of the electric motor) in order to move the elevator car 102 along the elevator shaft 104. The elevator drive system 122 may for example generate at least one elevator drive profile, e.g. an elevator speed profile and/or a torque profile, and drive the elevator car 102 in accordance with the generated at least one drive profile. The elevator system 100 may further comprise one or more known elevator related entities, e.g. user interface devices, elevator doors, and/or safety circuit and devices, etc., which are not shown in FIG. 1 for sake of clarity.

When using the reduced buffers 118a, 118b, an Emergency Terminal Speed Limiting (ETSL) function is required according to elevator standards to implement Emergency Terminal Slowdown (ETS). To implement the ETSL function, the elevator system 100 comprises at least one ETSL device 124a, 124b arranged to each terminal area of the elevator shaft 104. The ETSL devices 124a, 124b monitor the speed of the elevator car 102 at the terminal areas of the elevator shaft 104. The speed monitoring of the elevator car 102 by the ETSL devices 124a, 124b is independent of the speed control of the elevator system 100 performed with the elevator drive system 122. The terminal areas, i.e. terminal zones, of the elevator shaft 104 are a bottom terminal area, i.e. the pit of the elevator shaft 104, and a top terminal area. In other words, the elevator system 100 comprises at least one ETSL device 124a, 124b arranged to the bottom terminal area of the elevator shaft 104 and at least one ETSL device 124a, 124b arranged to the top terminal area of the elevator shaft 104. The number of the ETSL devices 124a, 124b arranged to each terminal area of the elevator shaft 104 may depend on the nominal speed of the elevator car 102. According to a non-limiting example, when the nominal speed of the elevator car 102 is 2.5 m/s, one ETSL device 124a, 124b may be arranged to each terminal area of the elevator shaft 104. According to another non-limiting example, when the nominal speed of the elevator car 102 is 4.5 m/s, three ETSL devices 124a, 124b may be arranged to each terminal area of the elevator shaft 104. In the example of FIG. 1, one ETSL device 124a is arranged to the bottom terminal area of the elevator shaft 104 and one ETSL device 124b is arranged to the top terminal area of the elevator shaft 104. However, the elevator system 100 may also comprise more than one ETSL device 124a, 124b arranged to each terminal area of the elevator shaft 104. The location of the at least one ETSL device 124a, 124b in the terminal area of the elevator shaft 104, e.g. a distance from the terminal floor 106a, 106n, may depend on the nominal speed of the elevator car 102. Each ETSL device 124a, 124b is assigned with a limit value, i.e. a speed limit value. The limit value of the ETSL device 124a, 124b, i.e. the limit value assigned to the ETSL device 124 a, 124b, is a maximum allowed speed of the elevator car 102 at the terminal areas of the elevator shaft 104. If the speed of the elevator car 102 exceeds the limit value of the ETSL device 124a, 124b at the location of the ETSL device 124a, 124b, the ETSL device 124a, 124b opens the safety circuit of the elevator system 100 to remove the power from the electric motor and the hoisting machinery brakes 114a, 114b. The actuation of the ETSL device 124a, 124b causes an emergency stop of the elevator car 102. The limit value of the ETSL devices 124a, 124b may depend on the elevator system 100 e.g., design of the buffers 118a, 118b, the nominal speed of the elevator car 102, moving masses, and/or the terminal areas of the elevator shaft 104, etc. The ETSL devices 124a, 124b and the ETSL function are the final backup, in case the normal terminal slowdown fails to slow down the elevator car 102 at the terminal areas of elevator shaft 104.

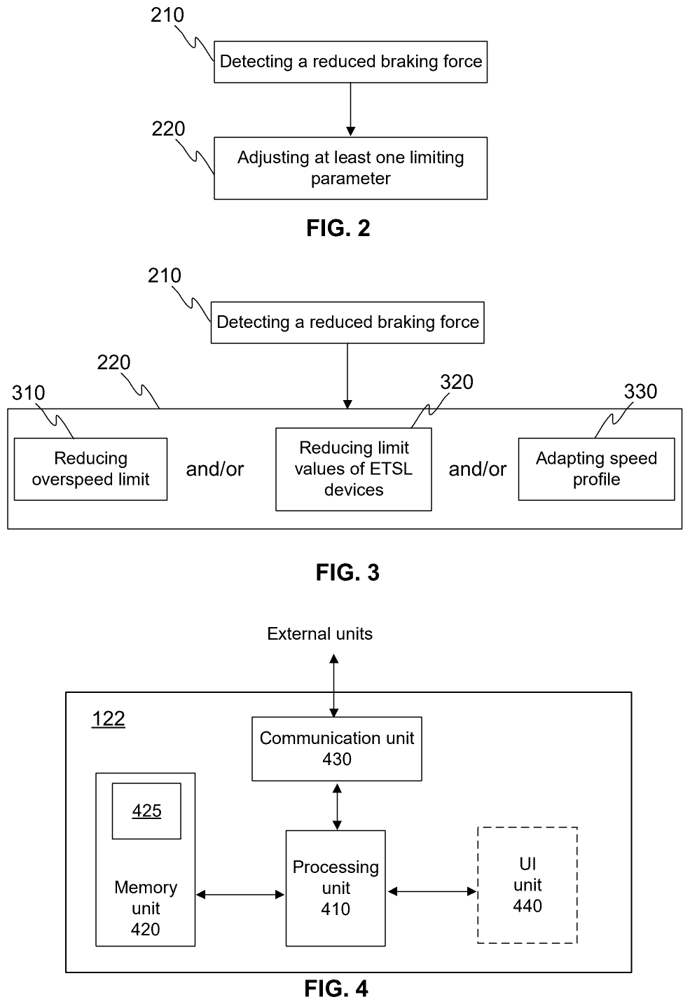

Next an example of a safety method for the elevator system 100 comprising the reduced buffers 118a, 118b is described by referring to FIG. 2, which illustrates schematically the safety method as a flow chart. The method is performed by the elevator drive system 122 of the elevator system 100.

At a step 210, the elevator drive system 122 detects a reduced braking force of the hoisting machinery brake arrangement. The reduced braking force may for example be detected during a condition monitoring test of the hoisting machinery brake arrangement. If the hoisting machinery brakes 114a, 114b are used to stop unintended movement of the elevator car 102 in an Unintended Car Movement Protection (UCMP) solution of the elevator system 100, regular condition monitoring test of the hoisting machinery brakes 114a, 114b is required according to elevator standards. The condition monitoring test of the hoisting machinery brake arrangement may for example be performed daily. According to an example, the condition monitoring test may comprise monitoring a braking capacity of the hoisting machinery brake arrangement by monitoring the braking force of each hoisting machinery brake 114a, 114b of the hoisting machinery brake arrangement. For example, in a hoisting machinery brake arrangement comprising two hoisting machinery brakes 114a, 114b, each hoisting machinery brake 114a, 114b is designed to be able to stop and hold an empty elevator car 102 at standstill alone. The braking force may gradually decrease for example due to dirt, grease, etc. on a brake pad of the hosting machinery brake 114a, 114b or on a surface of the traction sheave 112. For example, oil on the surface of the traction sheave 112 may cause reduced braking force of the hoisting machinery arrangement. To detect the reduced braking force of the hoisting machinery brake arrangement it is sufficient to detect a reduced braking force of at least one hoisting machinery brake 114a, 114b of the hoisting machinery brake arrangement. In other words, if a reduced braking force of at least one of the hoisting machinery brakes 114a, 114b is detected, the reduced braking force of the whole hoisting machinery brake arrangement is detected. The detection of the reduced braking force may for example comprise detecting that the braking force of at least one hoisting machinery brake 114a, 114b of the hoisting machinery brake arrangement decreases below a predefined braking force limit. The condition monitoring test of the hoisting machinery brake arrangement is performed when the elevator car 102 is empty, at standstill, and the elevator doors are closed. In the condition monitoring test of the hoisting machinery brake arrangement one hoisting machinery brake 114a, 114b is lifted, i.e. opened, at a time and a movement representing a rotation of the electric motor is monitored. The movement may be monitored based on movement data obtained from a positioning device. The positioning device may for example be a motor encoder, a door zone sensor, or any other sensor device capable of obtaining the movement data. According to an example, a mere detection of the movement representing the rotation of the electric motor during the lifting of one of the hoisting machinery brakes 114a, 114b (i.e. a detection that a single hoisting machinery brake 114a, 114b cannot hold the empty elevator car 102 at standstill as it should) may be used as an indication that the braking force of said hoisting machinery brake 114a, 114b of the hoisting machinery brake arrangement is below the predefined braking force limit, i.e. the braking force of said hoisting machinery brake 114a, 114b is reduced and thus also the braking force of the whole hoisting machinery brake arrangement is reduced. According to another example, in case the movement representing the rotation of the electric motor during the lifting of one of the hoisting machinery brakes 114a, 114b is not detected (i.e. the elevator car 102 is still at standstill), the condition monitoring testing may further comprise that the elevator drive system 112 starts to gradually drive the electric motor to provide torque against the single hoisting machinery brake 114a, 114b. The provided torque may for example be obtained from a motor control system (e.g., calculated from motor currents). When a movement representing the rotation of the electric motor is detected, the braking force of the single hoisting machinery brake 114a, 114b may be defined, e.g. calculated or estimated, based on the additional torque provided at the moment when the movement is detected. In this example, if the defined braking force of at least one hoisting machinery brake 114a, 114b is below the predefined braking force limit, the braking force of said hoisting machinery brake 114a, 114b is reduced and thus also the braking force of the whole hoisting machinery brake arrangement is reduced. In addition to the detection of the reduced braking force, in this example the amount of the reduced braking force, i.e. the amount the braking force is below the braking force limit, may be defined. According to yet another example, the reduced braking force may be detected by monitoring the force generated by each hoisting machinery brake 114a, 114b. The force generated by each hoisting machinery brake 114a, 114b may for example be monitored by one or more force sensors. In this example, if the monitored braking force of at least one hoisting machinery brake 114a, 114b is below the predefined braking force limit, the braking force of said hoisting machinery brake 114a, 114b is reduced and thus also the braking force of the whole hoisting machinery brake arrangement is reduced. In addition to the detection of the reduced braking force, in this example the amount of the reduced braking force may be defined.

At a step 220, in response to detecting the reduced braking force at the step 210, the elevator drive system 122 adjusts at least one limiting parameter limiting an elevator motion. This enables that the operation of the elevator system 100 may still be continued with a limited performance in spite of the detection of the reduced braking force. In other words, the elevator system 100 does not need to be taken out of operation, when the reduced braking force of the hoisting machinery brake arrangement is detected, for example while waiting for the repair of the hoisting machinery brake arrangement. This, in turn, decreases the downtime of the elevator system 100. The elevator motion represents the motion of the elevator car 102. The elevator motion may for example be the motion of the elevator car 102, the motion of the counterweight 108, and/or any other motion caused by the electric motor to drive the elevator car 102.

FIG. 3 schematically illustrates the flow chart of FIG. 2 in more detailed manner. Especially the step 220 becomes clear from FIG. 3.

The adjustment of the at least one limiting parameter at the step 220 may comprise that the elevator drive system 122 reduces at a step 310 the overspeed limit of the elevator car 102. In other words, the at least one limiting parameter may comprise the overspeed limit of the elevator car 102 and the elevator drive system 122 may adjust the overspeed limit. According to an example, the overspeed limit of the elevator car 102 may be reduced to the rated striking speed of the buffers 118a, 118b. When the overspeed limit is reduced to the rated striking speed of the buffers 118a, 118b, the amount of the reduced braking force is not necessary to be known. According to another example, the overspeed of the elevator car 102 may be reduced to a speed value corresponding to the reduced braking force, if the amount of the reduced braking force has been defined. The speed value corresponding to the reduced braking force is lower than the initial overspeed value (i.e. the overspeed value before the reduction), but higher than the rated striking speed of the buffers 118a, 118b. The reducing the overspeed limit to the speed value corresponding to the reduced braking force enables that the elevator car 102 may be driven at a speed higher than the rated striking speed of the buffers 118a, 118b, but the speed of the elevator car 102 may still be slowed down to the rated striking speed of the buffers regardless of the reduced braking force.

Alternatively or in addition, the adjustment of the at least one limiting parameter at the step 220 may comprise that the elevator drive system 122 reduces at a step 320 the limit values of the ETSL devices 124a, 124b. In other words, the at least one limiting parameter may alternatively or in addition comprise the limit values of the ETSL devices 124a, 124b and the elevator drive system 122 may adjust the limit values of the ETSL devices 124a, 124b. Each ETSL device 124a, 124b may comprise input means, e.g. one or more input devices, for receiving the adjusted limit value and processing means, e.g. a processing unit comprising one or more processors, for performing the adjusting of the limit value. Each ETSL device 124a, 124b may further comprise memory means, e.g. a memory unit comprising one or more memories, for storing the reduced limit value. For example, the ETSL device 124a, 124b may be a switch device comprising the mentioned entities of the ETSL device and being capable of monitoring the speed of the elevator car 102. When the reduced braking force is detected, in order to be able to slow down the speed of the elevator car 102 by actuating the ETSL device 124a, 124b sufficiently from the perspective of the dimensioning of the reduced buffers 118a, 118b, the limit values of the ETSL devices 124a, 124b need to be reduced. The needed reduction of the limit values of the ETSL devices 124a, 124b may depend on the amount of the reduced braking force. According to an example, the limit values of the ETSL devices 124a, 124b may be reduced to the rated striking speed of the buffers 118a, 118b. When the limit values of the ETSL devices 124a, 124b are reduced to the rated striking speed of the buffers 118a, 118b, the amount of the reduced braking force is not necessary to be known. When actuated (i.e. when the speed of the elevator car 102 exceeds the reduced limit value of the ETSL device), the ETSL device 124a, 124b stops the elevator motion by opening the safety circuit to remove power from the electric motor and the hoisting machinery brakes 114a, 114b, such that the rated striking speed of the buffers 118a, 118b is not exceeded. According to another example, the limit values of the ETSL devices 124a, 124b may be reduced to limit values corresponding to the reduced braking force, if the amount of the reduced braking force has been defined. The limit values corresponding to the reduced braking force are lower than the initial limit values (i.e. the limit values before the reduction), but higher than the rated striking speed of the buffers 118a, 118b.

Alternatively or in addition, the adjustment of the at least one limiting parameter at the step 220 may comprise that the elevator drive system 122 adapts at a step 330 the elevator speed profile. More specifically, the adjustment of the at least one limiting parameter at the step 220 may comprise that the elevator drive system 122 reduces the maximum speed of the elevator speed profile. In other words, the at least one limiting parameter may alternatively or in addition comprise the maximum speed of the elevator speed profile and the elevator drive system 122 may adjust the maximum speed of the elevator speed profile. According to an example, the maximum speed of the elevator speed profile may be reduced to the rated striking speed of the buffers 118a, 118b. When the maximum speed of the elevator speed profile is reduced to the rated striking speed of the buffers 118a, 118b, the amount of the reduced braking force is not necessary to be known. According to another example, the maximum speed of the elevator speed profile may be reduced to a maximum speed value corresponding to the reduced braking force, if the amount of the reduced braking force has been defined. The maximum speed value corresponding to the reduced braking force is lower than the initial maximum speed (i.e. the maximum value before the reduction), but higher than the rated striking speed of the buffers 118a, 118b. The reducing the maximum speed of the elevator speed profile to the maximum speed value corresponding to the reduced braking force enables that the elevator car 102 may be driven at a speed higher than the rated striking speed of the buffers 118a, 118b, but the speed of the elevator car 102 may still be slowed down to the rated striking speed of the buffers regardless of the reduced braking force. FIG. 4 illustrates schematically an example of components of the elevator drive system 122. The elevator drive system 122 may comprise a processing unit 410 comprising one or more processors, a memory unit 420 comprising one or more memories, a communication unit 430 comprising one or more communication devices, and possibly a user interface (UI) unit 440. The mentioned elements may be communicatively coupled to each other with e.g. a communication bus. The memory unit 420 may store and maintain portions of a computer program (code) 425, and data. The computer program 425 may comprise instructions which, when the computer program 425 is executed by the processing unit 410 of the elevator drive system 122 may cause the processing unit 410, and thus the elevator drive system 122 to carry out desired tasks, e.g. one or more of the method steps described above. The processing unit 410 may thus be arranged to access the memory unit 420 and retrieve and store any information therefrom and thereto. For sake of clarity, the processor herein refers to any unit suitable for processing information and control the operation of the elevator drive system 122, among other tasks. The operations may also be implemented with a microcontroller solution with embedded software. Similarly, the memory unit 420 is not limited to a certain type of memory only, but any memory type suitable for storing the described pieces of information may be applied in the context of the present invention. The communication unit 430 provides one or more communication interfaces for communication with any other unit, e.g. the electric motor, the hoisting machinery brakes 114a, 114b, the at least one ETSL device 124a, 124b, one or more databases, and/or with any other unit. The user interface unit 440 may comprise one or more input/output (I/O) devices, such as buttons, keyboard, touch screen, microphone, loudspeaker, display and so on, for receiving user input and outputting information. The computer program 425 may be a computer program product that may be comprised in a tangible nonvolatile (non-transitory) computer-readable medium bearing the computer program code 425 embodied therein for use with a computer, i.e. the elevator drive system 122.

The specific examples provided in the description given above should not be construed as limiting the applicability and/or the interpretation of the appended claims. Lists and groups of examples provided in the description given above are not exhaustive unless otherwise explicitly stated.

1. A safety method for an elevator system comprising reduced buffers, the method comprises:
detecting a reduced braking force of a hoisting machinery brake arrangement, and
adjusting at least one limiting parameter limiting an elevator motion in response to detecting the reduced braking force, wherein the elevator motion represents a motion of an elevator car of elevator system.

2. The method according to claim 1, wherein the reduced braking force is detected during a condition monitoring test of the hoisting machinery brake arrangement.

3. The method according to claim 1, wherein the detecting the reduced braking force comprises detecting that a braking force of at least one hoisting machinery brake of the hoisting machinery brake arrangement decreases below a predefined braking force limit.

4. The method according to claim 1, wherein the adjusting of the at least one limiting parameter comprises reducing an overspeed limit of the elevator car.

5. The method according to claim 4, wherein the overspeed limit of the elevator car is reduced to a rated striking speed of the buffers or to a speed value corresponding to the reduced braking force.

6. The method according to claim 1, wherein the adjusting of the at least one limiting parameter comprises reducing limit values of Emergency Terminal Speed Limiting (ETSL) devices of the elevator system.

7. The method according to claim 6, wherein the limit values of the ETSL devices are reduced to a rated striking speed of the buffers or to limit values corresponding to the reduced braking force.

8. The method according to claim 1, wherein the adjusting of the at least one limiting parameter comprises reducing a maximum speed of an elevator speed profile.

9. The method according to claim 8, wherein the maximum speed of the elevator speed profile is reduced to a rated striking speed of the buffers or to a maximum speed value corresponding to the reduced braking force.

10. An elevator drive system of an elevator system comprising reduced buffers, the elevator drive system comprising:
at least one processor; and
at least one memory including computer program code;
wherein the at least one memory and the computer program code are configured to, with the at least one processor, cause the elevator drive system to perform:
detect a reduced braking force of a hoisting machinery brake arrangement, and
adjust at least one limiting parameter limiting an elevator motion in response to detecting the reduced braking force, wherein the elevator motion represents a motion of an elevator car of elevator system.

11. The elevator drive system according to claim 10, wherein the reduced braking force is detected during a condition monitoring test of the hoisting machinery brake arrangement.

12. The elevator drive system according to claim 10, wherein the detection of the reduced braking force comprises that the elevator drive system is configured to detect that a braking force of at least one hoisting machinery brake of the hoisting machinery brake arrangement decreases below a predefined braking force limit.

13. The elevator drive system according to claim 10, wherein the adjusting of the at least one limiting parameter comprises that the elevator drive system is configured to reduce an overspeed limit of the elevator car.

14. The elevator drive system according to claim 13, wherein the overspeed limit of the elevator car is reduced to a rated striking speed of the buffers or to a speed value corresponding to the reduced braking force.

15. The elevator drive system according to claim 10, wherein the adjusting of the at least one limiting parameter comprises that the elevator drive system is configured to reduce limit values of Emergency Terminal Speed Limiting (ETSL) devices of the elevator system.

16. The elevator drive system according to claim 15, wherein the limit values of the ETSL devices are reduced to a rated striking speed of the buffers or to limit values corresponding to the reduced braking force.

17. The elevator drive system according to claim 10, wherein the adjusting of the at least one limiting parameter comprises that the elevator drive system is configured to reduce a maximum speed of an elevator speed profile.

18. The elevator drive system according to claim 17, wherein the maximum speed of the elevator speed profile is reduced to a rated striking speed of the buffers or to a maximum speed value corresponding to the reduced braking force.

19. An elevator system comprising:
an elevator car arranged to travel along an elevator shaft;
a reduced buffer arrangement comprising reduced buffers;
a hoisting machinery brake arrangement comprising at least two hoisting machinery brakes; and
an elevator drive system according to claim 10.

20. The method according to claim 2, wherein the detecting the reduced braking force comprises detecting that a braking force of at least one hoisting machinery brake of the hoisting machinery brake arrangement decreases below a predefined braking force limit.
